(19) United States
(12) Patent Application Publication
(10) Pub. No.: US 2026/0251434 A1
(43) Pub. Date: Aug. 27, 2026

(54) COORDINATE MEASUREMENT MACHINE ASSEMBLY FOR ELEVATION WORK ASSEMBLIES

(71) Applicant: Terex South Dakota, Inc., Watertown, SD (US)

(72) Inventors: David C. HOUSER, Elkton, MD (US); Jeremy NISSING, Bothell, WA (US)

(21) Appl. No.: 19/063,499

(22) Filed: Feb. 26, 2025

(51) Int. Cl. G01B 5/00; B66F 11/04; G01B 5/008

(52) U.S. Cl. CPC G01B 5/0004; B66F 11/04; G01B 5/008

(57) ABSTRACT

A machine assembly is provided with a coordinate measurement machine adapted to be installed to an elevation work subassembly to measure coordinates at an elevated workspace. A transmitter is in communication with the coordinate measurement machine to transmit coordinates to a receiver that is remote from the elevation work subassembly. An elevation work assembly is provided with a manipulator assembly to manipulate a workpiece. The coordinate measurement machine is installed on the manipulator assembly to measure coordinates at the elevated workspace. A receiver is remote from the aerial work platform, and in communication with the transmitter to receive the coordinates from the transmitter.

### TECHNICAL FIELD

Various embodiments relate to elevation work assemblies, such as multi-purpose elevating platforms, and aerial work platforms.

### BACKGROUND

The prior art has provided aerial work platforms for performing work operations at elevated workspaces.

### SUMMARY

According to an embodiment, a machine assembly is provided with a coordinate measurement machine adapted to be installed to an elevation work subassembly to measure coordinates at an elevated workspace. A transmitter is in communication with the coordinate measurement machine to transmit coordinates to a receiver that is remote from the elevation work subassembly.

According to a further embodiment, a stylus provided on the coordinate measurement machine to measure physical coordinates at the elevated workspace.

According to another further embodiment, a vision system is provided to measure visual coordinates at the elevated workspace.

According to another further embodiment, a receiver is in communication with the transmitter to receive the coordinates from the transmitter.

According to an even further embodiment, a media device is in communication with the receiver to display the coordinates.

According to another even further embodiment, equipment is provided in communication with the receiver to operate on a workpiece in response to the coordinates.

According to another even further embodiment, the receiver is in wireless communication with the transmitter.

According to another embodiment, a manipulator assembly is provided and adapted to be mounted to an elevation work subassembly to manipulate a workpiece. The manipulator assembly is further provided with a machine assembly with a coordinate measurement machine adapted to be installed to the elevation work subassembly to measure coordinates at an elevated workspace. A transmitter is in communication with the coordinate measurement machine to transmit coordinates to a receiver that is remote from the elevation work subassembly.

According to a further embodiment, an industrial multiple axis robot is provided.

According to another further embodiment, an end effector is connected to the manipulator assembly to grasp the workpiece.

According to another embodiment, an aerial work platform assembly is provided with a platform sized to receive an operator. A machine assembly is installed upon the platform, and provided with a coordinate measurement machine adapted to be installed to the aerial work platform to measure coordinates at an elevated workspace. A transmitter is in communication with the coordinate measurement machine to transmit coordinates to a receiver that is remote from the aerial work platform.

According to a further embodiment, the machine assembly is retractable relative to the platform.

According to another embodiment, a land vehicle is provided with a chassis adapted to travel upon an underlying support surface. An aerial work platform assembly is supported upon the chassis and provided with a platform sized to receive an operator. A machine assembly is installed upon the platform, and provided with a coordinate measurement machine adapted to be installed to an aerial work platform to measure coordinates at an elevated workspace. A transmitter is in communication with the coordinate measurement machine to transmit coordinates to a receiver that is remote from the aerial work platform.

According to another embodiment, a method is provided by measuring coordinates at an elevated workspace. The coordinates are transmitted to a receiver that is remote from the elevated workspace.

According to a further embodiment, a workspace is traced to measure the coordinates.

According to another further embodiment, the coordinates of the elevated workspace are visually measured with a vision system.

According to another further embodiment, the coordinates are received at the receiver; and the coordinates are displayed on a display.

According to another further embodiment, the coordinates are received at the receiver, and the workpiece is operated on, in response to receipt of the coordinates.

According to another further embodiment, a workpiece is manipulated with a manipulator that provides a coordinate measurement machine.

According to another embodiment, an elevation work assembly is provided with an elevation work subassembly. A manipulator assembly is mounted to the elevation work subassembly to manipulate a workpiece. The manipulator assembly provides a coordinate measurement machine to measure coordinates at an elevated workspace. A transmitter is in communication with the coordinate measurement machine to transmit coordinates from the elevation work subassembly. A receiver is remote from the elevation work subassembly, and in communication with the transmitter to receive the coordinates from the transmitter.

According to some embodiments, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general embodiment includes a machine assembly that also includes a coordinate measurement machine adapted to be installed to an elevation work subassembly to measure coordinates at an elevated workspace. The assembly also includes a transmitter in communication with the coordinate measurement machine to transmit coordinates to a receiver that is remote from the elevation work subassembly. Other embodiments include corresponding computer systems, apparatus, and computer programs recorded on one or more computer storage devices, each configured to perform the actions of the methods.

Some embodiments may include one or more of the following features. The machine assembly may include a stylus provided on the coordinate measurement machine to measure physical coordinates. The machine assembly may include a vision system to measure visual coordinates. The machine assembly may include a receiver in communication with the transmitter to receive the coordinates from the transmitter. The machine assembly may include a media device in communication with the receiver to display the coordinates. The machine assembly may include equipment in communication with the receiver to operate on a workpiece in response to the coordinates. The receiver is in wireless communication with the transmitter. The coordinate measurement machine is provided by the manipulator assembly. The manipulator assembly may include an industrial multiple axis robot. The manipulator assembly may include an end effector connected to the manipulator assembly to grasp the workpiece. An aerial work platform assembly may include: a platform sized to receive an operator, and the machine assembly installed upon the platform. The machine assembly is retractable relative to the platform. A land vehicle may include: a chassis adapted to travel upon an underlying support surface, and the aerial work platform assembly supported upon the chassis. Implementations of the described techniques may include hardware, a method or process, or computer software on a computer-accessible medium.

Some general embodiments may include a method that also includes measuring coordinates at an elevated workspace. The method also includes transmitting the coordinates to a receiver that is remote from the elevated workspace. Other embodiments of this aspect include corresponding computer systems, apparatus, and computer programs recorded on one or more computer storage devices, each configured to perform the actions of the methods.

Some general embodiments may also include one or more of the following features. The method may include: tracing a workspace to measure the coordinates. The method may include: visually measuring the coordinates of the elevated workspace with a vision system. The method may include: receiving the coordinates at the receiver; and displaying the coordinates on a display. The method may include: receiving the coordinates at the receiver; and operating on a workpiece in response to receipt of the coordinates. The method may include: manipulating a workpiece with a manipulator that also provides a coordinate measurement machine. Implementations of the described techniques may include hardware, a method or process, or computer software on a computer-accessible medium.

Some general embodiments may include an elevation work assembly that also includes an elevation work subassembly. The assembly also includes a manipulator assembly mounted to the elevation work subassembly to manipulate a workpiece. The manipulator assembly also includes a coordinate measurement machine to measure coordinates at an elevated workspace. The assembly also includes a transmitter in communication with the coordinate measurement machine to transmit coordinates from the elevation work subassembly. The assembly also includes a receiver remote from the elevation work subassembly, in communication with the transmitter to receive the coordinates from the transmitter. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a perspective of an elevation work vehicle according to an embodiment, illustrated in a partially extended position;

FIG. 2 is a perspective view of an elevation work vehicle according to another embodiment, illustrated partially extended;

FIG. 3 is a perspective view of an elevation work vehicle according to another embodiment, having a boom assembly with the boom assembly in a retracted and lowered position;

FIG. 4 is a perspective view of the elevation work vehicle of FIG. 3, with the boom assembly in an extended and raised position;

FIG. 5 is a perspective view of an elevation work vehicle according to another embodiment, illustrated in a partially extended position, and in communication with a receiver;

FIG. 6 is a perspective view of an elevation work vehicle according to another embodiment, illustrated in a partially extended position, and in communication with a receiver;

FIG. 7 is a perspective view of a manipulator assembly according to another embodiment;

FIG. 8 is a perspective view of a coordinate measurement machine according to another embodiment;

FIG. 9 is a perspective view of a manipulator assembly according to another embodiment;

FIG. 10 is a perspective view of an elevation work vehicle according to another embodiment, illustrated in an extended position;

FIG. 11 is a perspective view of an elevation work vehicle according to another embodiment, illustrated in an extended position; and

FIG. 12 is a flow chart of a method according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc. are, in some instances, used herein to describe various elements in order of introduction, these elements should not be limited by these terms. These terms are only used to distinguish one element from another. For example, a first boom could be termed a second boom, and, similarly, a second boom could be termed a first boom, without departing from the scope of the various described embodiments. The first boom and the second boom are both booms, but they are not the same boom.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The terminology controller may be provided as one or more controllers or control modules for the various components and systems. The controller 84 and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

Multiple purpose elevation work assemblies (or subassemblies) refer to a machine or industrial truck that is operable to carry an operator, goods, workpieces, a manipulator, a measurement device, or other equipment to an elevated workspace. These assemblies are operated to raise operators, goods, measurement devices, equipment, workpieces, or the like to the elevated workspace. Such assemblies may also be operable to translate in a horizontal direction for coordinated movement in vertical and horizontal directions. These assemblies may include a platform to support and raise an operator, goods, workpieces, or equipment.

Multiple purpose elevation subassemblies may also be incorporated into a land vehicle, known as a multi-purpose elevating platform (MPEP). MPEPs often include a chassis for travel upon an underlying support surface. The chassis may be supported upon wheels, tracks, or the like, for support and travel of the chassis. A mast, linkage, boom, or other armature is supported upon the chassis for raising the multiple purpose elevation subassembly to the elevated workspace. The MPEPs often include a platform, forks, or other tooling or equipment to support the operators, goods, measurement devices, equipment, workpieces, or the like upon the mast, linkage, boom, or armature. The chassis may include a powertrain for self-propulsion of the MPEP as a land vehicle. Alternatively, the chassis may be driven by an external propulsion device. The chassis may include a hitch to be towed by an external vehicle. The chassis may include one or more outriggers to extend from the chassis and support the chassis upon an underlying support surface, such as the ground.

Multiple purpose elevation work assemblies provide an operator platform on a linkage assembly that pivots and/or translates to lift the operator platform to an elevated worksite, and are often referred to as aerial lift assemblies. Conventional multiple purpose elevation work assemblies include various adjustable structures to lift an operator platform to a height for performing a work operation. The multiple purpose elevation work assemblies often include a stack linkage assembly. The multiple purpose elevation work assemblies often include an articulated and/or telescopic boom assembly, which may be provided by a four-bar linkage mechanism or an extending riser type linkage. Multiple purpose elevation work assemblies often include sequencing mast lift assemblies, telehandlers, material lifts, aerial work platforms, and the like. Multiple purpose elevation work assemblies are often provided on land vehicles for transportation of an operator platform to the worksite. Although aerial lift assemblies are illustrated and described, any industry machinery or construction equipment may be utilized.

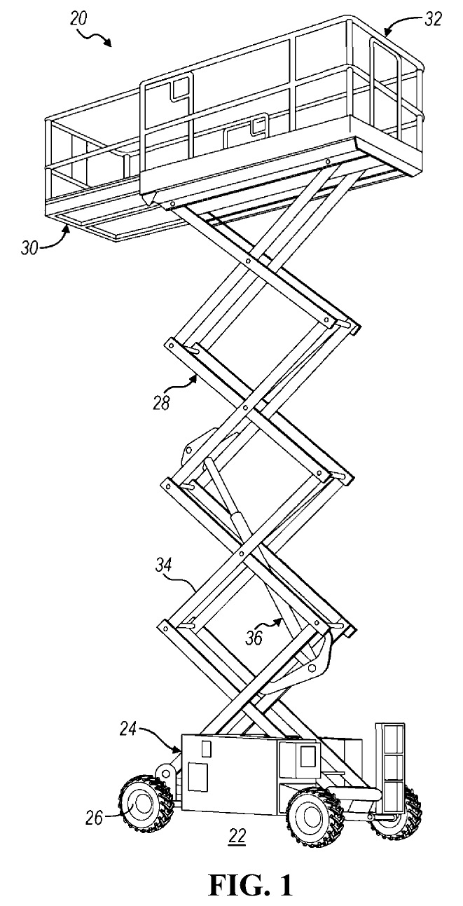

FIG. 1 illustrates an aerial lift assembly 20 according to an embodiment of a multiple purpose elevation work assembly 20. The aerial lift assembly 20 is a mobile aerial lift assembly 20 such as a land vehicle, which is collapsible for transportation upon an underlying support surface 22, such as the ground or a floor (FIG. 1). The aerial lift assembly 20 is also transportable for towing and transport upon a trailer behind a truck. The aerial lift assembly 20 is expandable by operator control to lift an operator to an elevated worksite. The aerial lift assembly 20 is discussed with relation to the ground 22. Therefore, terms such as upper, lower, and other height related terms are relative to height from the ground 22 are not to limit the aerial lift assembly 20 to ground 22 specific applications.

The aerial lift assembly 20 includes a lift structure that provides significant stability and performance characteristics by elevating a worker to an advantageous position for reach while providing stability. The aerial lift assembly 20 includes a chassis 24 to support the aerial lift assembly 20 upon the ground 22 or any support surface. The chassis 24 is supported upon a plurality of wheels 26 that contact the ground 22. A linkage assembly 28 is connected to the chassis 24 to extend and retract from the chassis 24. A platform 30 is provided on the linkage assembly 28 to extend and retract from the chassis 24. The platform 30 includes perimeter railing 32 extending upward from the platform 30 to enclose an operator workspace upon the platform 30.

The aerial lift assembly 20 is utilized to lift the platform 30 and workers to elevated work locations to perform work operations. The linkage assembly 28 is a stack linkage assembly 28, with a series of pivotally connected stack links 34 that retract to collapse and stack upon the chassis 24 for compactness for storage and transportation. The aerial lift assembly 20 also includes an actuator assembly 36 to extend and retract the linkage assembly 28 and consequently, extend and retract the platform 30. According to another embodiment, the aerial lift assembly 20 may include one or more outriggers on the chassis 24 to contact the ground 22 and to support and/or stabilize the lift assembly 20 upon the ground 22.

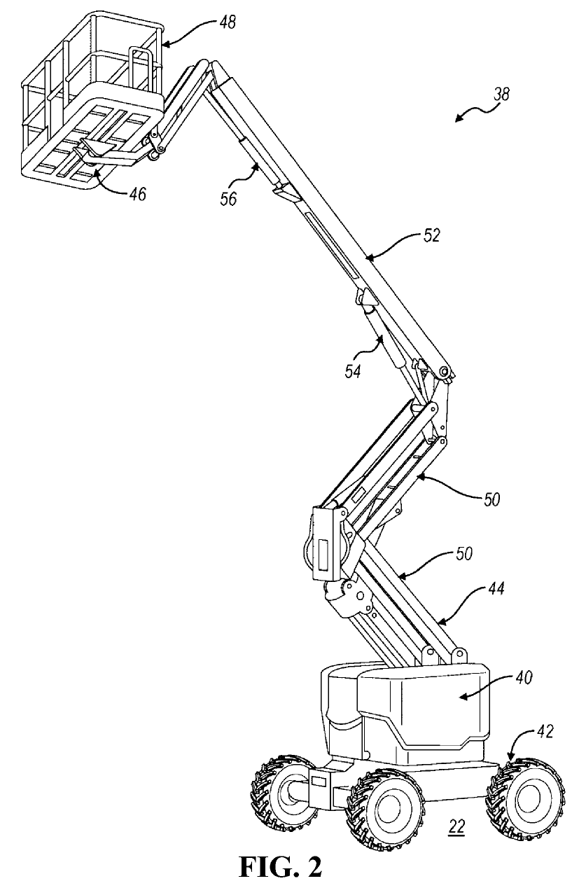

FIG. 2 illustrates an aerial lift assembly 38 according to another embodiment of a multiple purpose elevation work assembly 38. The aerial lift assembly 38 includes a chassis 40 to support the aerial lift assembly 38 upon the ground 22. The chassis 40 is supported upon a plurality of wheels 42 that contact the ground 22 for support and mobility of the aerial lift assembly 38. A linkage assembly 44 is connected to the chassis 40 to extend and retract from the chassis 40. A platform 46 is provided on the linkage assembly 44 with a perimeter railing 48. The linkage assembly 44 includes a plurality of four bar linkages 50 with an extendable boom 52. Actuator assemblies 54 are provided to pivot the four bar linkages 50 and the extendable boom 52. An actuator assembly 56 is provided to extend the boom 52. According to another embodiment, the aerial lift assembly 38 may include one or more outriggers on the chassis 40 to contact the ground 22 and to support and/or stabilize the lift assembly 38 upon the ground 22.

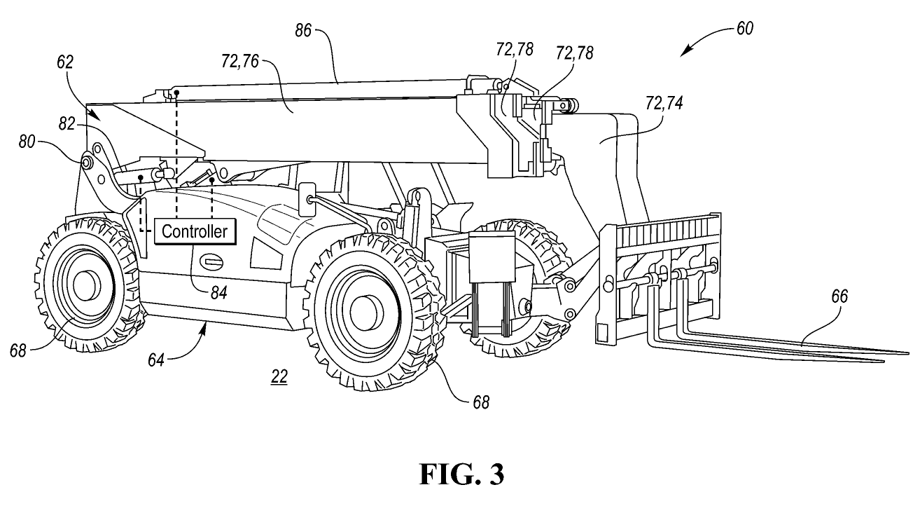

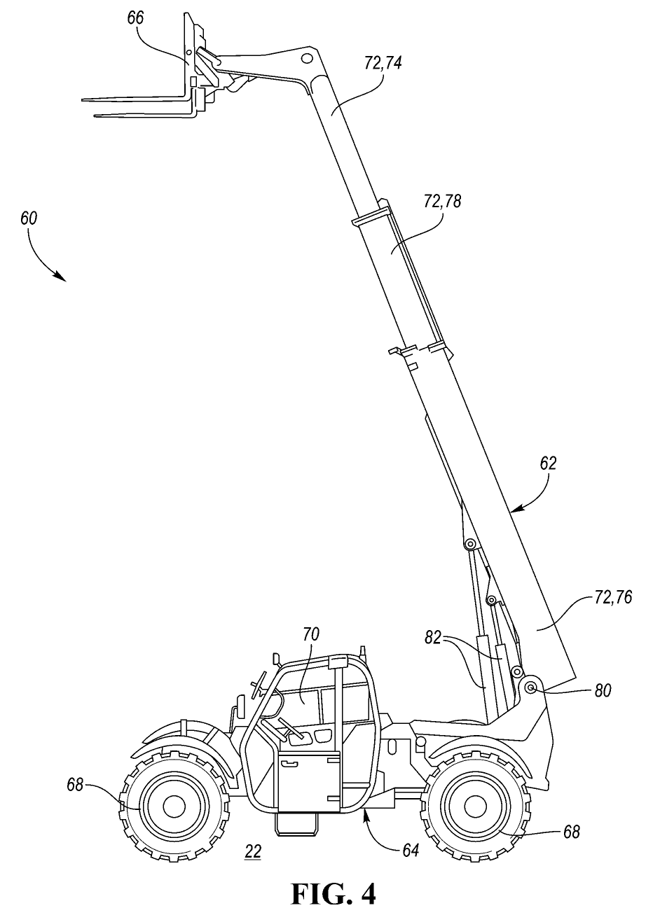

Referring to FIGS. 3 and 4, a lift device 60 is illustrated according to another embodiment of a multiple purpose elevation work assembly 60. The lift device 60 is an aerial lift assembly and may be a land vehicle, and is depicted as a telehandler 60. The lift device 60 has a boom assembly 62 that is movably secured to a chassis 64. More specifically, the boom assembly 62 may be pivotably or rotatably secured to the chassis 64. Tooling 66 may be secured to an opposing end of the boom assembly 62 relative to the chassis 64. The tooling 66 may comprise one or more tools that are operable to handle materials and other various loads. For example, the tooling 66 may comprise a fork that is operable to engage and handle materials or other loads. The tooling 66 may be raised or lowered relative to the chassis bvia the boom assembly 62. Alternatively, a mobile operator work platform may be secured to the opposing end of the boom assembly 62 relative to the chassis 64. Such a mobile platform may be raised or lowered relative to the chassis 64 via the boom assembly 62.

The lift device 60 is configured for lifting a load, such as a person, tools, cargo, and the like, with respect to an underlying support surface, such as paved or unpaved ground, a road, an apron such as a sidewalk or parking lot, an interior or exterior floor of a structure, or other surfaces. Traction devices, such as wheels 68, support the lift device 60 on the underlying surface. The wheels 68 may be propelled by a power generating device such as an internal combustion engine, or an electric motor. The lift device 60 may include a cockpit or a cabin 70 (FIG. 4) that includes a seat for an operator and various controls to operate the lift device 60. Such various controls may include various user interfaces for controlling the lift device 60. For example, the controls may include an accelerator pedal to accelerate the lift device 60; a brake pedal to slow the lift device 60; a steering wheel to turn the wheels 68 to steer the lift device 60 toward a desired direction; touchscreens, control buttons, knobs, levers, dials, or any other user interface to raise and lower the boom assembly 62; and touchscreens, control buttons, knobs, levers, dials, or any other user interface to extend and retract the boom assembly 62.

The boom assembly 62 may be telescopic and may include a series of telescopic tubes, telescopic extensions, or telescopic booms 72 that extend from each other and retract into each other. The boom assembly 62 includes at least two telescopic booms 72 that are arranged from an innermost boom 74 to an outermost boom 76. If the boom assembly 62 has three or more telescopic booms 72, intermediate booms 78 will be arranged between the innermost boom 74 and the outermost boom 76. Each telescopic boom 72 may be referred to as an inner or internal boom or may be referred to as outer or external boom relative to each of the other telescopic booms 72 based on relative positions. For example, the outermost boom 76 may be an outer or external boom relative to the innermost boom 74 and each of the intermediate booms 78; the innermost boom 74 may be an inner or internal boom relative to the outermost boom 76 and each of the intermediate booms 78; each intermediate boom 78 may be an inner or internal boom relative to the outermost boom 76; and each intermediate boom 78 may be an outer or external boom relative to the innermost boom 74. Furthermore, if a first of the telescopic booms 72 is disposed within a second of the telescopic booms 72, then the first of the telescopic booms 72 will be referred to as the inner or internal boom while the second of the telescopic booms 72 will be referred to an outer or external boom when relating the first and second of the telescopic booms 72 to each other.

The boom assembly 62 is illustrated in a retracted and lowered position in FIG. 3. The boom assembly 62 is illustrated in an extended and raised position in FIG. 4. The boom assembly 62 may be configured to pivot upward and downward relative to the chassis 64 along pin 80. One or more actuators 82 may be configured to pivot the boom assembly 62 relative to the chassis 64. The one or more actuators 82 may be electrical (e.g., electrical motors or cylinders operated by an electrical solenoid), hydraulic (e.g., hydraulic cylinders operated by opening and closing hydraulic valves), pneumatic (e.g., pneumatic cylinders operated by opening and closing pneumatic valves), or any other actuator known by a person of ordinary skill in the art.

One or more user interfaces (e.g., touchscreens, control buttons, knobs, levers, dials, or any other user interface know in the art), which may be disposed in the cabin 70, may directly operate the one or more actuators 82 or may send a signal to a controller 84, which in turn operates the one or more actuators 82.

The telescopic booms 72 of the boom assembly 62 may be configured to extend from and retract into each other. One or more actuators 86 may be configured to extend and retract the telescopic booms 72. The one or more actuators 86 may be electrical (e.g., electrical motors or cylinders operated by an electrical solenoid), hydraulic (e.g., hydraulic cylinders operated by opening and closing hydraulic valves), pneumatic (e.g., pneumatic cylinders operated by opening and closing pneumatic valves), or any other actuator known by a person of ordinary skill in the art.

One or more user interfaces (e.g., touchscreens, control buttons, knobs, levers, dials, or any other user interface know in the art), which may be disposed in the cabin 70, may directly operate the one or more actuators 86 or may send a signal to the controller 84, which in turn operates the one or more actuators 82, 86.

While illustrated as one controller 84, the controller 84 may be part of a larger control system and may be controlled by various other controllers 84 throughout the lift device 60. It should therefore be understood that the controller 84 and one or more other controllers can collectively be referred to as a “controller” that controls various actuators in response to signals from various sensors to control functions of the lift device 60. The controller 84 may include a microprocessor or central processing unit (CPU) in communication with various types of computer readable storage devices or media (e.g., a non-transitory computer readable medium having instructions stored thereon). Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 84 in controlling the lift device 60 or the subsystems of the lift device 60. Likewise, the controller 84, or a similar controller 84 may be provided on one of the aerial lift assemblies 20, 38 of the prior embodiments. An interface for the controller 84 may be provided on the platform 30, 46 of the prior embodiments 20, 38 of FIGS. 1 and 2.

Control logic or functions performed by the controller 84 may be represented by flow charts or similar diagrams in one or more Figures. These Figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 84. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the lift device 60 or its subsystems. The computer-readable storage devices or media may include one or more of a quantity of known physical devices which utilize electric, magnetic, and/or optical storage to keep executable instructions and associated calibration information, operating variables, and the like.

In various examples, the lift device 60 may be provided as a utility vehicle with a mobile work platform assembly such as an aerial work platform, a rough terrain telescopic load handler, portable material lift, telehandler, stack linkage lift, telescopic and articulating boom, and the like. According to another embodiment, the lift device 60 may include one or more outriggers on the chassis 64 to contact the ground 22 and to support and/or stabilize the lift device 60 upon the ground 22.

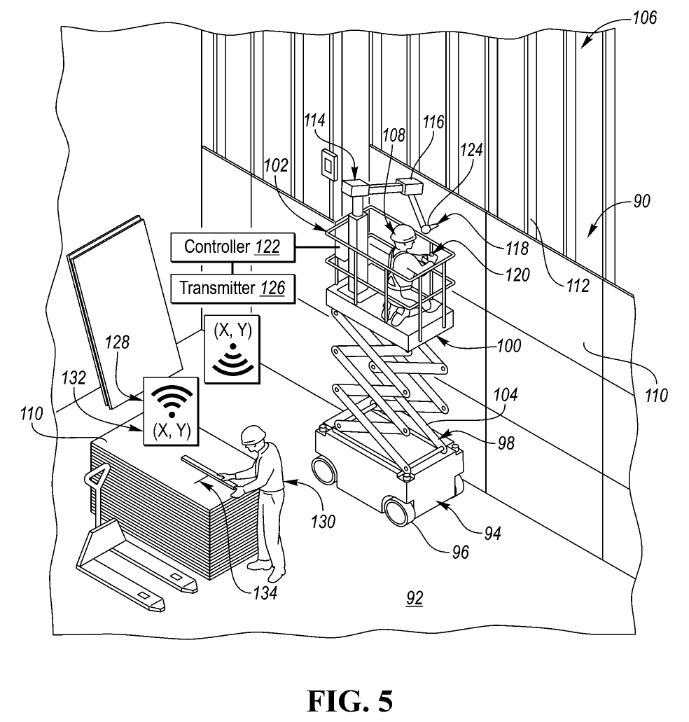

FIG. 5 illustrates an aerial lift assembly 90 according to an embodiment of a multiple purpose elevation work assembly 90. The aerial lift assembly 90 is a mobile aerial lift assembly 90 such as a land vehicle, which is collapsible for transportation upon an underlying support surface 92, such as the ground or a floor. The aerial lift assembly 90 is also transportable for towing and transport upon a trailer behind a truck. The aerial lift assembly 90 is expandable by operator control to lift an operator to an elevated worksite. The aerial lift assembly 90 is discussed with relation to the ground 92. Therefore, terms such as upper, lower, and other height related terms are relative to height from the ground 92 are not to limit the aerial lift assembly 90 to ground 92 specific applications.

The aerial lift assembly 90 includes a lift structure that provides significant stability and performance characteristics by elevating a worker to an advantageous position for reach while providing stability. The aerial lift assembly 90 includes a chassis 94 to support the aerial lift assembly 90 upon the ground 92 or any support surface. The chassis 94 is supported upon a plurality of wheels 96 that contact the ground 92. A linkage assembly 98 is connected to the chassis 94 to extend and retract from the chassis 94. A platform 100 is provided on the linkage assembly 98 to extend and retract from the chassis 94. The platform 100 includes perimeter railing 102 extending upward from the platform 100 to enclose an operator workspace upon the platform 100.

The aerial lift assembly 90 is utilized to lift the platform 100 and workers to elevated work locations to perform work operations. The linkage assembly 98 is a stack linkage assembly 98, with a series of pivotally connected stack links 104 that retract to collapse and stack upon the chassis 94 for compactness for storage and transportation. The aerial lift assembly 90 also includes an actuator assembly to extend and retract the linkage assembly 98 and consequently, extend and retract the platform 100, as disclosed in prior embodiments. According to another embodiment, the lift assembly 90 may include one or more outriggers on the chassis 94 to contact the ground 92 and to support and/or stabilize the lift assembly 90 upon the ground 92.

FIG. 5 illustrates the aerial lift assembly 90 in a work environment 106 for utilization at an elevated workspace. In the depicted embodiment, a first operator 108 is supported upon the platform 100 to install an array of panels 110 (such as drywall panels 110) to an upright support surface provided by a plurality of upright support members 112 (such as lumber studs 112). Although installation of drywall panels 110 is illustrated, any elevated work operation may utilize the aerial lift assembly 90.

In many at-height construction applications, such as installing paneling, conduit, etc., operators make measurements in order to properly size installed materials. Support personnel utilize these measurements to prepare materials for the aerial work platform 100 operators 108. Measurements are typically taken with a tape measure and are conveyed in written form. Operators 108 that work at-height often position materials 110 or workpieces 110 manually or utilize crude ad hoc fabrications for supporting a payload.

The aerial lift assembly 90 includes a machine assembly 114 installed to the platform 100, as a subassembly of the aerial lift assembly 90. According to an embodiment, the machine assembly 114 may be collapsible or retractable for storage when not employed. According to at least one embodiment, the machine assembly 114 is further defined as a coordinate measurement machine 114 for measuring coordinates at the elevated workspace. In the depicted embodiment, the machine assembly 114 includes a multiple axis armature 116 with multiple degrees of freedom for articulation to the workspace. According to an embodiment, the armature 116 of the machine assembly 114 is manually operated by the operator 108. The armature 116 is manually positioned by a manual force, according to one embodiment. The armature 116 in another embodiment, is an industrial manipulator 116, such as an assist device 116 to help the operator 108 lift and maneuver an end effector 118 at a distal end of the armature 116.

According to another embodiment, the armature 116 is controlled by manual inputs from the operator 108 input into an interface 120, such as a pendant 120, to control motion of the armature 116 by a controller 122, illustrated schematically in FIG. 5. The controller 122 may be similar to the controllers of prior embodiments, and may be in communication with the interface 120 and the machine assembly 114. The controller 122 may be separate from a controller of the aerial work platform assembly 90, or may be the same controller as the controller of the aerial work platform assembly 90. Likewise, the interface 120 may be separate from an interface of the aerial work platform assembly 90, or may be a common interface 120 with the interface for the aerial work platform assembly 90. According to yet another embodiment, the armature 116 is a multiple axis industrial robot 116 that is operated by a program in the controller 122.

In the depicted embodiment, the end effector 118 is operable to engage a workpiece 110, and/or the work environment 106 by physically contacting the workpiece 110 or work environment 106. For example, the end effector 118 includes a stylus 124 to physically detect and trace the elevated workspace to measure coordinates at the elevated height.

The controller 122 is in communication with the stylus 124 and the armature 116 to receive signals indicative of measured coordinates. The coordinates may be in one or more axes (x; x and y; or x, y, and z). The controller 122 is also in communication with a transmitter 126 illustrated schematically in FIG. 5. The controller 122 may also store the measurement coordinates for subsequent retrieval, such as retrieval upon request.

The transmitter 126 is operated to transmit the measured coordinates to a receiver 128 that is remote from the aerial work platform 100. The receiver 128 is in wireless communication with the transmitter 126 according to one embodiment. The wireless communication may be any suitable format. For example, the wire communication may include: WiFi, which uses radio frequencies to send and receive data, allowing communication, such as internet communication without cables; Bluetooth® (a registered trademark of BLUETOOTH SIG, INC., a corporation of Delaware with an address at Suite 350, 5209 Lake Washington Boulevard, Kirkland, Washington, US 98033), which allows users to connect electronic devices wirelessly to a system to transfer data; infrared communication, which uses invisible light waves to send and receive data; satellite communication, which provides global connectivity regardless of population density; cellular communication, which provides broadband communication; radio transmission, which involves transmitting information over a distance without the use of wires, cables, or other electrical conductors; Wireless local loop (WLL), also called a Fixed Wireless Loop, which is a widely used technology for wireless communication systems; broadcast radio, which involves sending data in the form of radio waves to receiving antennae; or any other suitable wireless communication format. According to another embodiment, the receiver 128 may be wired to receive the coordinates from the transmitter 126.

As illustrated in FIG. 5, a second operator 130 is provided at a location remote from the elevated aerial work platform 100. For example, the second operator 130 may be located at ground level 92. The second operator 130 utilizes a media device 132, such as a laptop, a smartphone, an interface, or the like. The media device 132 is in communication with the receiver 128. According to an embodiment, the receiver 128 is housed within the media device 132. The media device 132 is operable to communicate the measured coordinates from the receiver 128. For example, the media device 132 includes a display to display the coordinates.

The ground operator 130 is equipped with equipment 134, such as tools to perform operations upon workpieces 110 in response to the coordinates. The ground operator 130 is also provided with an inventory of workpieces 110 to perform the operations upon the workpieces 110. According to another embodiment, the second operator 130 and the equipment 134 are automation equipment to automatically operate on the workpieces in response to receipt of the coordinates from the receiver 128. The ground operator 130 prepares workpieces 110 for installation without disrupting the elevated operator 108.

According to another embodiment, the end effector 118 is operable to grasp the workpieces 110 to manipulate the workpieces for placement for installation, and/or for installation. For example, the end effector 118 may include one more vacuum grippers to grasp, support, and move the workpieces 110. According to other examples, the end effector 118 may embody a clamp, a gripper, a fork, or any suitable tool for lift and manipulating a workpiece 110. Likewise, the armature 116 may load assist as a manipulator or robot, for movement, maneuvering, positioning, and/or installation of the workpieces 110.

The manually controlled, coordinate measuring and manipulating device 114 is installed as an attachment on the aerial work platform 100. This machine assembly 114 broadens the capability of a typical manipulating device 116 by adding functionality which enables the elevated operator 108 to use the machine assembly 114 as a coordinate measuring device 114. The machine assembly increases the capability of the manipulator armature 116, enhancing its viability as a tool for operators in industry. This added capability eliminates taking of measurements manually, and increases efficiency by transferring the measurements directly to associated personnel.

According to another embodiment, the operations at the elevated workspace are automated and performed by the machine assembly 114, as a remotely controlled armature 116 or as a programmed robot 116. Under this example, the armature 116 provides all measuring and installing operations at the elevated workspace, thereby freeing the first operator 108 from travel to the elevated workspace. Further, under this example, the railing 102 can be omitted. Additionally, the platform 100 may be sized to support the armature 116 only, or omitted altogether.

Although the aerial lift assembly 90 is illustrated with a stack linkage assembly 98, the machine assembly 114 may be utilized with any suitable multiple purpose elevation work device, such as the articulated boom assembly 38 of FIG. 2, the telehandler 60 of FIGS. 3 and 4, or any other suitable multiple purpose elevation work device.

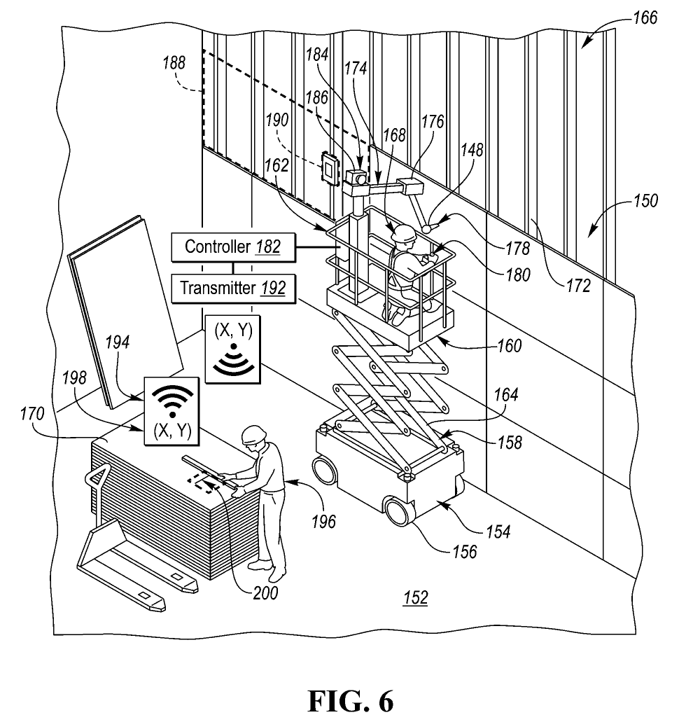

FIG. 6 illustrates an aerial lift assembly 150 according to another embodiment of a multiple purpose elevation work assembly 150. The aerial lift assembly 150 is a mobile aerial lift assembly 150 such as a land vehicle, which is collapsible for transportation upon an underlying support surface 152, such as the ground or a floor. The aerial lift assembly 150 is also transportable for towing and transport upon a trailer behind a truck. The aerial lift assembly 150 is expandable by operator control to lift an operator to an elevated worksite. The aerial lift assembly 150 is discussed with relation to the ground 152. Therefore, terms such as upper, lower, and other height related terms are relative to height from the ground 152 are not to limit the aerial lift assembly 150 to ground 152 specific applications.

The aerial lift assembly 150 includes a lift structure that provides significant stability and performance characteristics by elevating a worker to an advantageous position for reach while providing stability. The aerial lift assembly 150 includes a chassis 154 to support the aerial lift assembly 150 upon the ground 152 or any support surface. The chassis 154 is supported upon a plurality of wheels 156 that contact the ground 152. A linkage assembly 158 is connected to the chassis 154 to extend and retract from the chassis 154. A platform 160 is provided on the linkage assembly 158 to extend and retract from the chassis 154. The platform 160 includes perimeter railing 162 extending upward from the platform 160 to enclose an operator workspace upon the platform 160.

The aerial lift assembly 150 is utilized to lift the platform 160 and workers to elevated work locations to perform work operations. The linkage assembly 158 is a stack linkage assembly 158, with a series of pivotally connected stack links 164 that retract to collapse and stack upon the chassis 154 for compactness for storage and transportation. The aerial lift assembly 150 also includes an actuator assembly to extend and retract the linkage assembly 158 and consequently, extend and retract the platform 160, as disclosed in prior embodiments. According to another embodiment, the lift assembly 150 may include one or more outriggers on the chassis 154 to contact the ground 152 and to support and/or stabilize the lift assembly 150 upon the ground 152.

FIG. 6 illustrates the aerial lift assembly 150 in a work environment 166 for utilization at an elevated workspace. In the depicted embodiment, a first operator 168 is supported upon the platform 160 to install an array of panels 170 (such as drywall panels 170) to an upright support surface provided by a plurality of upright support members 172 (such as lumber studs 172). Although installation of drywall panels 170 is illustrated, any elevated work operation may utilize the aerial lift assembly 150.

The aerial lift assembly 150 includes a machine assembly 174 installed to the platform 160, as a subassembly of the aerial lift assembly 150. According to an embodiment, the machine assembly 174 may be collapsible or retractable for storage when not employed. According to at least one embodiment, the machine assembly 174 is further defined as a coordinate measurement machine 174 for measuring coordinates at the elevated workspace. In the depicted embodiment, the machine assembly 174 includes a multiple axis armature 176 with multiple degrees of freedom for articulation to the workspace. According to an embodiment, the armature 176 of the machine assembly 174 is manually operated by the operator 168. The armature 176 is manually positioned by a manual force, according to one embodiment. The armature 176 in another embodiment, is an industrial manipulator 176, such as an assist device 176 to help the operator 168 lift and maneuver an end effector 178 at a distal end of the armature 176.

According to another embodiment, the armature 176 is controlled by manual inputs from the operator 168 input into an interface 180, such as a pendant 180, to control motion of the armature 176 by a controller 182, illustrated schematically in FIG. 6. The controller 182 may be similar to the controllers of prior embodiments, and may be in communication with the interface 180 and the machine assembly 174. The controller 182 may be separate from a controller of the aerial work platform assembly 150, or may be the same controller as the controller of the aerial work platform assembly 150. Likewise, the interface 180 may be separate from an interface of the aerial work platform assembly 150, or may be a common interface 180 with the interface for the aerial work platform assembly 150. According to yet another embodiment, the armature 176 is a multiple axis industrial robot 176 that is operated by a program in the controller 182.

In at least some embodiments, the end effector 178 is operable to engage a workpiece 170, and/or the work environment 166 by physically contacting the workpiece 170 or work environment 166. For example, the end effector 178 includes a stylus 148 to physically detect and trace the elevated workspace to measure coordinates at the elevated height.

In the depicted embodiment, the machine assembly 174 includes a vision system 184 with a camera 186 installed on the machine assembly 174. The vision system 184 measures visual coordinates including workpiece areas, volumes, or perimeters 188 and obstacles 190 within the perimeters 188. The vision system 184 automatically identifies reference features and the position and dimensions of simple shapes of objects 190 on the wall 172. These positions and dimensions are sent to remote support personnel in order to prepare materials 170 for installation on the wall 172. The stylus 148 and the vision system 184 may be operated interchangeably or in cooperation for taking measurements at the elevated workspace.

The controller 182 is in communication with the stylus 148, the vision system 184, and the armature 176 to receive signals indicative of measured coordinates. The controller 182 is also in communication with a transmitter 192 illustrated schematically in FIG. 6. The controller 182 may also store the measurement coordinates for subsequent retrieval, such as retrieval upon request.

The transmitter 192 is operated to transmit the measured coordinates to a receiver 194 that is remote from the aerial work platform 160. The receiver 194 is in wireless communication with the transmitter 192 according to one embodiment. The wireless communication may be any suitable format. According to another embodiment, the receiver 194 may be wired to receive the coordinates from the transmitter 192.

As illustrated in FIG. 6, a second operator 196 is provided at a location remote from the elevated aerial work platform 160. For example, the second operator 196 may be located at ground level 152. The second operator 196 utilizes a media device 198, such as a laptop, a smartphone, an interface, or the like. The media device 198 is in communication with the receiver 194. According to an embodiment, the receiver 194 is housed within the media device 198. The media device 198 is operable to communicate the measured coordinates from the receiver 194. For example, the media device 198 includes a display to display the coordinates.

The ground operator 196 is equipped with equipment 200, such as tools to perform operations upon workpieces 170 in response to the coordinates. The ground operator 196 is also provided with an inventory of workpieces 170 to perform the operations upon the workpieces 170. According to another embodiment, the second operator 196 and the equipment 200 are automation equipment to automatically operate on the workpieces in response to receipt of the coordinates from the receiver 194. The ground operator 196 prepares workpieces 170 for installation without disrupting the elevated operator 168.

According to another embodiment, the end effector 178 is operable to grasp the workpieces 170 to manipulate the workpieces for placement for installation, and/or for installation. For example, the end effector 178 may include one more vacuum grippers to grasp, support, and move the workpieces 170. According to other examples, the end effector 117 may embody a clamp, a gripper, a fork, or any suitable tool for lift and manipulating a workpiece 170. Likewise, the armature 176 may load assist as a manipulator or robot, for movement, maneuvering, positioning, and/or installation of the workpieces 170.

The manually controlled, coordinate measuring and manipulating device 174 is installed as an attachment on the aerial work platform 160. This machine assembly 174 broadens the capability of a typical manipulating device 176 by adding functionality which enables the elevated operator 168 to use the machine assembly 174 as a coordinate measuring device 174. The machine assembly increases the capability of the manipulator armature 176, enhancing its viability as a tool for operators in industry. This added capability eliminates taking of measurements manually, and increases efficiency by transferring the measurements directly to associated personnel.

According to another embodiment, the operations at the elevated workspace are automated and performed by the machine assembly 174, as a remotely controlled armature 176 or as a programmed robot 176. Under this example, the armature 176 provides all measuring and installing operations at the elevated workspace, thereby freeing the first operator 168 from travel to the elevated workspace. Further, under this example, the railing 162 can be omitted. Additionally, the platform 160 may be sized to support the armature 176 only, or omitted altogether.

Although the aerial lift assembly 150 is illustrated with a stack linkage assembly 158, the machine assembly 174 may be utilized with any suitable multiple purpose elevation work device, such as the articulated boom assembly 38 of FIG. 2, the telehandler 60 of FIGS. 3 and 4, or any other suitable multiple purpose elevation work device.

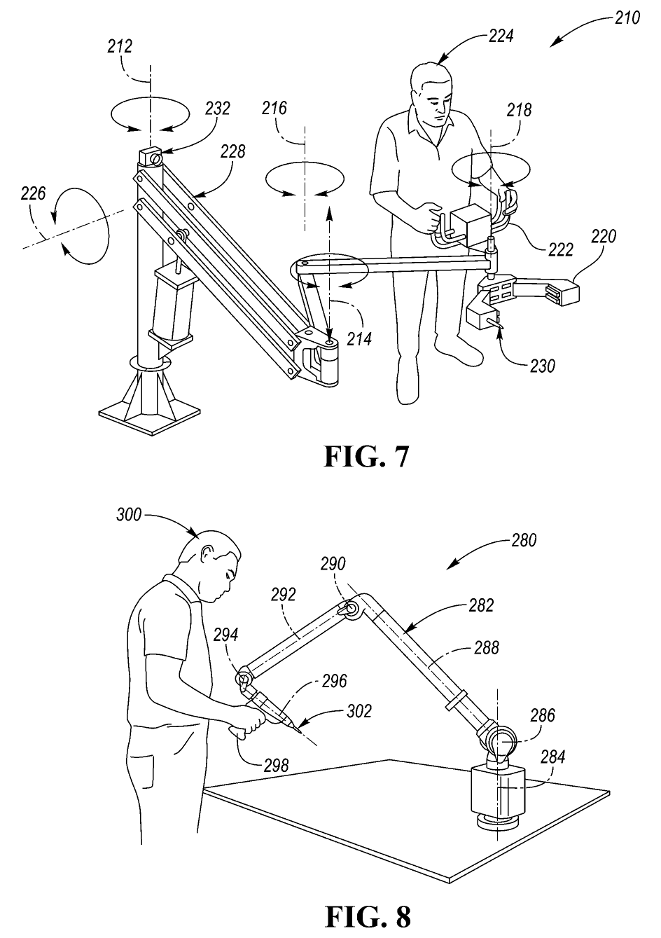

Various manipulator assemblies may be utilized, depending on the applicable work operation and workpiece. FIG. 7 illustrates a manipulator assembly 210 according to an embodiment, which includes multiple vertical axes 212, 214, 216, 218 for additional flexibility. The manipulator assembly 210 includes another degree of freedom about a horizontal axis 226. The manipulator assembly 210 includes a linkage assembly 228 for adjustment about the horizontal axis 226 for adjustment of height. The manipulator assembly 210 includes an end effector 220 with a gripper for gripping a workpiece by a compressive clamping force, according to an embodiment. The manipulator assembly 210 also includes a pair of handles 222 to be grasped by an operator 224. The linkage assembly 228 may include a four-bar parallelogram linkage 228 for consistent orientation of the end effector 220 at various heights. The manipulator assembly 210 illustrates a variation for handling loads of a varying load and size, which may involve enhanced ergonomics and maneuverability for operation or installation. The manipulator assembly 210 may be installed upon the multiple purpose elevation assembly 20, 38, 60, 90, 150 of any of the prior embodiments.

The manipulator assembly 210 may also be provided with a stylus 230 attached to the end effector 220 for physically engaging and measuring a workspace or workpiece. The stylus 230 may be retractable for clearance during a manipulation operation. Likewise, the stylus 230 is extendable as illustrated during a measuring operation as a coordinate measurement machine 230. The manipulator assembly 210 may also include a vision system 232 for measuring a workspace or workpiece visually. The vision system 232 may be installed upon the manipulator assembly 210 or installed remotely and in communication with the manipulator assembly 210. The coordinate measurement machine 230 may work in cooperation with the vision system 232 or may be employed independently. Likewise, the vision system 232 may also be utilized independent of the coordinate measurement machine 230.

FIG. 8 depicts another manipulator assembly 280, which is smaller and more compact for lighter applications, or for detecting coordinates with enhanced accuracy for precision work environments. The manipulator assembly 280 includes an armature 282 for seven pivotal axes 284, 286, 288, 290, 292, 294, 296 to provide several degrees of freedom for manipulation of the armature 282, which are illustrated as lengthwise pivotal axes 284, 288, 292, 296 and as pivotal connections 286, 290, 294. A handle 298 is provided at a distal end of the armature 282 to be grasped and manipulated by a manual operator 300. A stylus 302 of a coordinate measurement machine 302 is provided on a distal end of the handle 298. The manipulator assembly 280 provides a lightweight physical touch coordinate measurement machine 302 with lightweight or negligible force assistance to the operator 300.

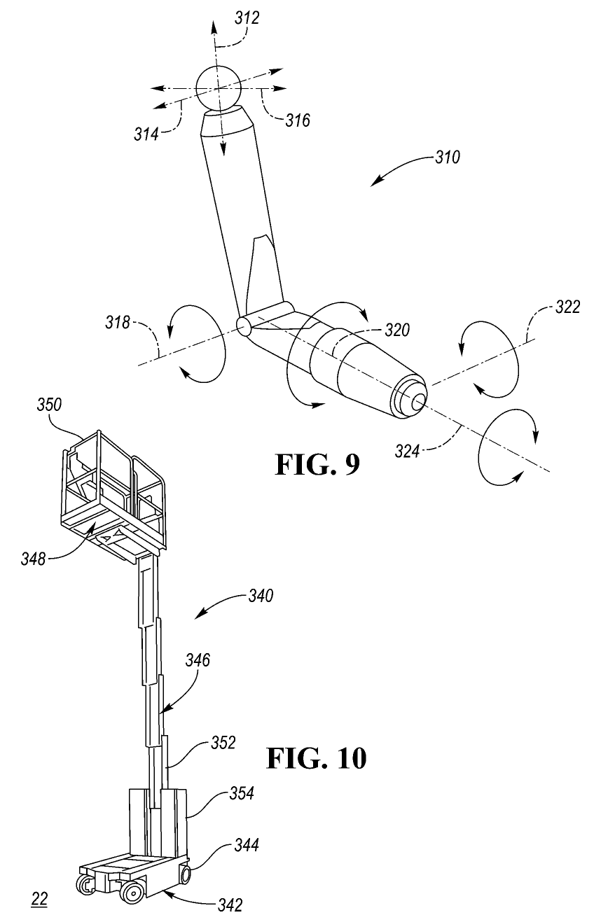

An armature 310 is illustrated in FIG. 9 for a manipulator assembly of another embodiment. The armature 310 includes seven degrees of freedom with rotation about seven axes 312, 314, 316, 318, 320, 322, 324. The armature 310 mimics the degrees of freedom of a human arm and provides a humanoid style of manipulation. The armature 310 can be attached to a multiple purpose elevation work assembly, and manipulated by remote instructions that are manually input or programmed for live manual controls or automatic operation.

FIG. 10 illustrates an aerial lift assembly 340 according to an embodiment of a multiple purpose elevation work assembly 340. The aerial lift assembly 340 is a mobile aerial lift assembly 340 such as a land vehicle, which is collapsible for transportation upon an underlying support surface 22, such as the ground or a floor. The aerial lift assembly 340 is also transportable for towing and transport upon a trailer behind a truck. The aerial lift assembly 340 is expandable by operator control to lift an operator to an elevated worksite. The aerial lift assembly 340 is discussed with relation to the ground 22. Therefore, terms such as upper, lower, and other height related terms are relative to height from the ground 22 are not to limit the aerial lift assembly 340 to ground 22 specific applications.

The aerial lift assembly 340 includes a lift structure that provides significant stability and performance characteristics by elevating a worker to an advantageous position for reach while providing stability. The aerial lift assembly 340 includes a chassis 342 to support the aerial lift assembly 340 upon the ground 22 or any support surface. The chassis 342 is supported upon a plurality of wheels 344 that contact the ground 22. An expandable mast assembly 346 is connected to the chassis 342 to extend and retract from the chassis 342. A platform 348 is provided on the expandable mast assembly 346 to extend and retract from the chassis 342. The platform 348 includes perimeter railing 350 extending upward from the platform 348 to enclose an operator workspace upon the platform 348. The coordinate measurement machine 124, 148, 230, 302, vision system 184, 232, and/or manipulators 114, 174, 210, 280, 310 of the prior embodiments may be installed upon the platform 348 or driven directly by the expandable mast assembly 346.

The aerial lift assembly 340 is utilized to lift the platform 348 and workers to elevated work locations to perform work operations. The expandable mast assembly 346 includes a sequential series of interconnected rails 352 that cooperate to each translate from the chassis 342 to extend as illustrated, and to retract to align and stack upon the chassis 342 for compactness for storage and transportation. The aerial lift assembly 340 also includes an actuator assembly to extend and retract the expandable mast assembly 346 and consequently, extend and retract the platform 348. According to another embodiment, the aerial lift assembly 340 may include one or more outriggers on the chassis 342 to contact the ground 22 and to support and/or stabilize the lift assembly 340 upon the ground 22.

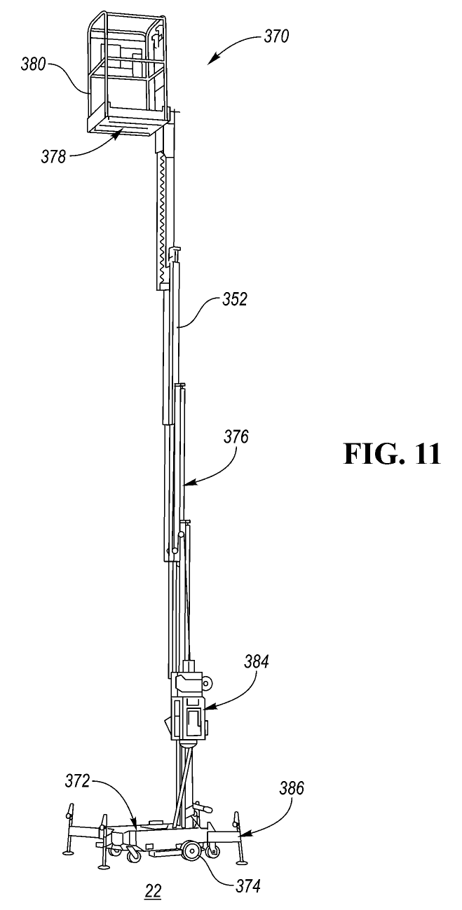

FIG. 11 illustrates an aerial lift assembly 370 according to an embodiment of a multiple purpose elevation work assembly 370. The aerial lift assembly 370 is a mobile aerial lift assembly 370 such as a land vehicle, which is collapsible for transportation upon an underlying support surface 22, such as the ground or a floor. The aerial lift assembly 370 is also transportable for towing and transport upon a trailer behind a truck. The aerial lift assembly 370 is expandable by operator control to lift an operator to an elevated worksite. The aerial lift assembly 370 is discussed with relation to the ground 22. Therefore, terms such as upper, lower, and other height related terms are relative to height from the ground 22 are not to limit the aerial lift assembly 370 to ground 22 specific applications.

The aerial lift assembly 370 includes a lift structure that provides significant stability and performance characteristics by elevating a worker to an advantageous position for reach while providing stability. The aerial lift assembly 370 includes a chassis 372 to support the aerial lift assembly 370 upon the ground 22 or any support surface. The chassis 372 is supported upon a plurality of wheels 374 that contact the ground 22. An expandable mast assembly 376 is connected to the chassis 372 to extend and retract from the chassis 372. A platform 378 is provided on the expandable mast assembly 376 to extend and retract from the chassis 372. The platform 378 includes perimeter railing 380 extending upward from the platform 378 to enclose an operator workspace upon the platform 378. The coordinate measurement machine 124, 148, 230, 302, vision system 184, 232, and/or manipulators 114, 174, 210, 280, 310 of the prior embodiments may be installed upon the platform 378 or driven directly by the expandable mast assembly 376.

The aerial lift assembly 370 is utilized to lift the platform 378 and workers to elevated work locations to perform work operations. The expandable mast assembly 376 includes a sequential series of interconnected rails 382 that cooperate to each translate from the chassis 372 to extend as illustrated, and to retract to align and stack upon the chassis 372 for compactness for storage and transportation. The aerial lift assembly 370 also includes an actuator assembly 384 to extend and retract the expandable mast assembly 376 and consequently, extend and retract the platform 378. According to an embodiment, the aerial lift assembly 370 includes one or more outriggers 386 on the chassis 372 to contact the ground 22 and to support and/or stabilize the lift assembly 370 upon the ground 22.

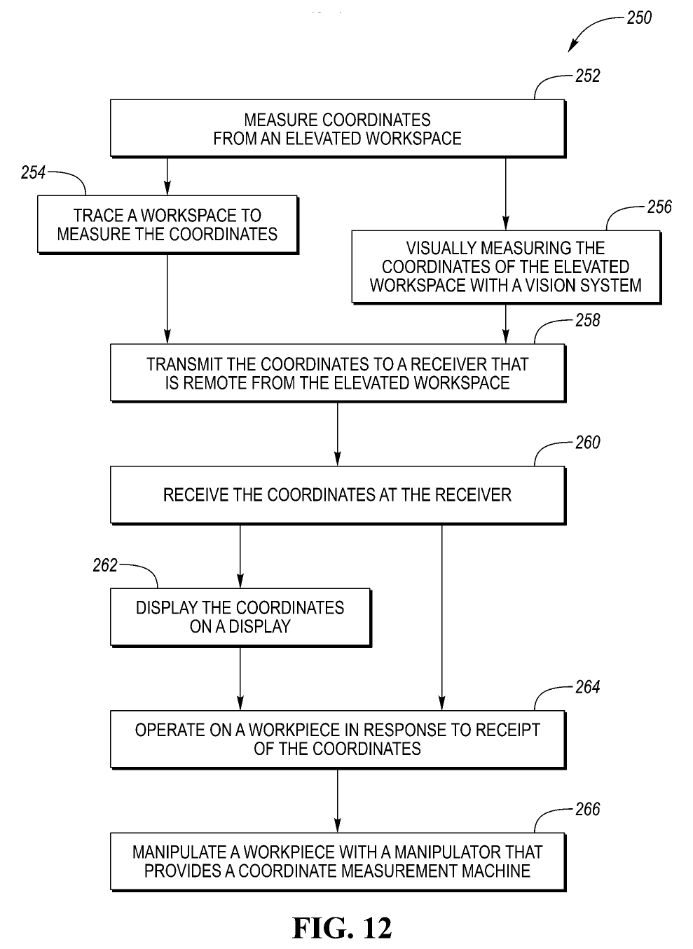

FIG. 12 illustrates a method 250 according to various embodiments. At step 252, coordinates are measured from an aerial work platform 100, 160 at an elevated workspace. According to one embodiment, a workspace is traced to measure the coordinates at block 254. According to another embodiment, the coordinates are visually measured with a vision system 184 at block 256. At step 258, the coordinates are transmitted to a receiver 128, 194 that is remote from the aerial work platform 100, 160. At block 260, the coordinates are received at the receiver 128, 194. In the option with a display, the coordinates are displayed on the display at block 262. Then, at step 264, the workpiece 110, 170 is under operation in response to receipt of the coordinates. At block 266, the workpiece 110, 170 is manipulated with a manipulator 114, 174 that supports a coordinate measurement machine.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A machine assembly comprising:
a coordinate measurement machine adapted to be installed to an elevation work subassembly to measure coordinates at an elevated workspace; and
a transmitter in communication with the coordinate measurement machine to transmit coordinates to a receiver that is remote from the elevation work subassembly.

2. The machine assembly of claim 1, further comprising a stylus provided on the coordinate measurement machine to measure physical coordinates at the elevated workspace.

3. The machine assembly of claim 2, further comprising a vision system to measure visual coordinates at the elevated workspace.

4. The machine assembly of claim 1, further comprising a vision system to measure visual coordinates at the elevated workspace.

5. The machine assembly of claim 1, further comprising a receiver in communication with the transmitter to receive the coordinates from the transmitter.

6. The machine assembly of claim 5, further comprising a media device in communication with the receiver to display the coordinates.

7. The machine assembly of claim 5, further comprising equipment in communication with the receiver to operate on a workpiece in response to the coordinates.

8. A manipulator assembly adapted to be mounted to an elevation work subassembly to manipulate a workpiece, the manipulator assembly further comprising the machine assembly of claim 1.

9. The manipulator assembly of claim 8, further comprising an industrial multiple axis robot.

10. The manipulator assembly of claim 8, further comprising an end effector connected to the manipulator assembly to grasp the workpiece.

11. An aerial work platform assembly comprising:
a platform sized to receive an operator; and
the machine assembly of claim 1 installed upon the platform.

12. The aerial work platform assembly of claim 11, wherein the machine assembly is retractable relative to the platform.

13. A land vehicle comprising:
a chassis adapted to travel upon an underlying support surface; and
the aerial work platform assembly of claim 11 supported upon the chassis.

14. A method comprising:
measuring coordinates at an elevated workspace; and
transmitting the coordinates to a receiver that is remote from the elevated workspace.

15. The method of claim 14, further comprising:
tracing a workspace to measure the coordinates.

16. The method of claim 14, further comprising:
visually measuring the coordinates of the elevated workspace with a vision system.

17. The method of claim 14, further comprising:
receiving the coordinates at the receiver; and
displaying the coordinates on a display.

18. The method of claim 14, further comprising:
receiving the coordinates at the receiver; and
operating on a workpiece in response to receipt of the coordinates.

19. The method of claim 14, further comprising:
manipulating a workpiece with a manipulator that comprises a coordinate measurement machine.

20. An elevation work assembly comprising:
an elevation work subassembly;
a manipulator assembly mounted to the elevation work subassembly to manipulate a workpiece, wherein the manipulator assembly comprises a coordinate measurement machine to measure coordinates at an elevated workspace;
a transmitter in communication with the coordinate measurement machine to transmit coordinates from the elevation work subassembly; and
a receiver remote from the elevation work subassembly, in communication with the transmitter to receive the coordinates from the transmitter.
